(19) United States
(12) Patent Application Publication
(10) Pub. No.: US 2010/0115910 A1
(43) Pub. Date: May 13, 2010

(54) FRUIT EXTRACTOR

(76) Inventor: Larry Mulock, Brush Prairie, WA (US)

Correspondence Address: RYLANDER & ASSOCIATES PC, P.O. Box 250, VANCOUVER, WA, 98660, US

(21) Appl. No.: 12/580,455

(22) Filed: Oct. 16, 2009

Related U.S. Application Data
(60) Provisional application No. 61/106,056, filed on Oct. 16, 2008.

(51) Int. Cl. A01D 46/24

(52) U.S. Cl. 56/335

(57) ABSTRACT

A fruit extractor including a container having an open top, blade slidably connected to said open top, such that said blade covers said open top in a closed position and uncovers said open top in a retracted position, a pole connected to said container, a retraction arm connected to said blade and pivotally connected to said pole, and a retraction line connected to said retraction arm for moving said arm to a retracted position.

### CROSS REFERENCE TO RELATED APPLICATION

This application is a non-provisional application claiming priority to co-pending provisional application Ser. No. 61/106,056 filed 16 Oct. 2008, and incorporated herein by reference.

### FIELD OF THE INVENTION

The present invention relates to apparatuses and methods for picking fruit and other natural food items from an elevated location.

### BACKGROUND

Fruit picking, such as apple picking, cherry picking, orange picking, frequently requires reaching high hanging fruit. This requires pickers to devise methods of reaching the fruit, such as climbing in a tree, using a ladder, picking from the back or top of a vehicle, among others.

It is desirable to have an apparatus which allows a fruit picker to easily reach up to a high hanging fruit and pick it without climbing into the tree, climbing up on a ladder or otherwise becoming elevated, and which eliminates the risk that the fruit will drop to the ground, becoming damaged, bruised, or dirtied.

Presently known art attempts to address this problem, but has not completely solved the problem. The following represents a list of known related art:

| | | Date of |
|---|---|---|
| Reference: | Issued to: | Issue/Publication: |
| U.S. Pat. No. 6,182,431 | Balchen | Feb. 6, 2001 |
| U.S. Pat. No. 5,857,316 | Murdock | Jan. 12, 1999 |
| U.S. Pat. No. 5,787,698 | Rushing | Aug. 4, 1998 |
| U.S. Pat. No. 5,724,799 | Hsia | Mar. 10, 1998 |
| U.S. Pat. No. 5,463,859 | Perry | Nov. 7, 1995 |
| U.S. Pat. No. 5,386,682 | Rodman | Feb. 7, 1995 |
| U.S. Pat. No. 5,083,418 | Reece | Jan. 28, 1992 |
| U.S. Pat. No. 4,928,461 | King | May 29, 1990 |
| U.S. Pat. No. 4,835,955 | Gaubis | Jun. 6, 1989 |
| U.S. Pat. No. 1,795,392 | Hardwick | Mar. 10, 1931 |
| U.S. Pat. No. 1,881,134 | Schling | Oct. 4, 1932 |
| U.S. Pat. No. 2,935,836 | Angel | May 10, 1960 |

The teachings of each of the above-listed citations (which does not itself incorporate essential material by reference) are herein incorporated by reference. None of the above inventions and patents, taken either singularly or in combination, is seen to describe the instant invention as claimed.

U.S. Pat. No. 6,182,431 to Balchen issued Feb. 6, 2001 for a “Fruit picking apparatus” discloses an apparatus for picking fruit comprises an elongate tube in which fruit is collected, a handle attached to the tube for enabling fruit to be picked from trees, a first plate at a top end of the tube for engaging a branch, the plate having a slot arranged to receive a stem of the fruit, a slidable member with an aligned slotted plate arranged to slide within the tube so that the plates move in opposite directions to break the fruit from its stem. The tube collects the fruit which can be seen through an opening. The slide is operated against a spring by a string extending along the handle.

U.S. Pat. No. 5,857,316 to Murdock issue Jan. 12, 1999 for a “Manual stem cutting and fruit collection apparatus” discloses a manual stem cutting and fruit removal apparatus. The device comprises a receptacle member and a handle attached thereto. A mouth and a blade are located adjacent at the top of the receptacle member. The blade is adjustably removable for case in replacement. A collection chamber is positioned beneath the mouth and the blade and includes a sloping surface for supporting the precut fruit and a cushioned surface for catching the fruit after the stem is severed. In use, the mouth receives the fruit while it is hanging on the tree. By manipulating the device, the blade engages and cuts the stem, and the fruit falls into the collection chamber.

U.S. Pat. No. 5,787,698 to Rushing issued Aug. 4, 1998 for a “High-reach fruit picker” discloses a fruit picker includes a rigid, hollow sleeve having an opening at the top end thereof, and a fruit engaging mechanism connected to the sleeve at the top end for engaging a piece of fruit. The fruit engaging mechanism includes a string attached at one end thereof to a first point on the sleeve, the string passing through a hole provided in the sleeve at a second point which is separated from the first point by a predetermined arcuate distance along a side of the sleeve. The opposite end of the string extends down the outside of the sleeve so that it can be grasped by a user of the fruit picker. The string defines, in conjunction with the side of the sleeve, a variable size opening in which the piece of fruit to be picked is received. The fruit engaging mechanism further includes a biasing mechanism which is slidably attached to the string for biasing the string away from the first and second point so as to increase the size of the variable size opening. After the piece of fruit has passed through the variable size opening, the user pulls on the opposite end of the string to thereby reduce the size of the variable size opening and trap the piece of fruit within the sleeve. Thereafter, downward movement of the sleeve causes the fruit engaging mechanism to sever the piece of fruit from the tree branch.

U.S. Pat. No. 5,724,799 to Hsia issued Mar. 10, 1998 for a “Fruit picker” discloses an apparatus to facilitate picking of fruits, one combination comprising a pole, a rigid basket which is mounted on the pole, and a cutter which is a plate having a cutting wedge or cutting wedges and which is mounted transversely on a side wall of the basket; another combination comprising a pole, a cutter mounting device which is clamped onto one end of the pole, a cutter which is a plate having a cutting wedge or cutting wedges and which is mounted on the cutter mounting device, a fruit holder mounting device which is mounted on the cutter mounting device, and a fruit holder which is a bag made of flexible material and which is mounted onto the fruit holder mounting device.

U.S. Pat. No. 5,463,859 to Perry issued Nov. 7, 1995 for a “Fruit picking apparatus” discloses a fruit picking apparatus for easily penetrating foliage to access fruit, and for removing fruit from a stem, including a generally cylindrical receptacle formed as a one piece construction and having a closed upper end, a closed lower end and a side wall extending therebetween, the upper end and the lower end being sloped to facilitate penetration of foliage, an opening for receiving fruit formed in the side wall intermediate the upper end and the lower end and terminating proximate the upper end with a convergent slot extending in the direction of the upper end, a shaft, and a threaded socket extending from the lower end of the receptacle along a longitudinal axis, for removably receiving a threaded end of the shaft.

U.S. Pat. No. 5,386,682 to Rodman issued Feb. 7, 1995 for a “Fruit picker apparatus” discloses a support shaft mounts a cutter frame having a curer cooperative with a stationary cutter to receive a tree limb therethrough to effect its severing. Basket structure is arranged for mounting below the cutter frame to receive the severed tree or fruit component.

U.S. Pat. No. 5,083,418 to Reece issued Jan. 28, 1992 for a “Hand-operated fruit picker” discloses a portable hand-operated fruit picker for mounting on a telescoping pole having a container or bag at one end thereof for receiving the fruit when removed from a tree. The portable hand-operated fruit picker consists primarily of a telescoping pole, a first hoop member fixed to the distal end of the upper section of the telescoping pole, a second hoop member pivotally mounted to the upper section of the telescoping pole adjacent its distal end, a container or bag fixed to the second hoop member, and a member for actuating the second hoop member relative to the first hoop member to facilitate the fruit picking process.

U.S. Pat. No. 4,928,461 to King issued May 29, 1990 for a “Fruit picking assembly” discloses a picking head and/or support frame for a fruit or like produce containing bag designed to be attached to the distal end of an elongated pole or shaft and including a cutting blade mounted thereon such that a worker may extend the bag and picking head to an elevated position so as to reach oranges or like fruit within a tree and easily sever the stem of such fruit so that it will be captured within the bag after being cut from the tree and wherein the picking head includes a support frame produced from a preferably one piece, high strength, light weight, moldable material.

U.S. Pat. No. 4,835,955 to Gaubis issued Jun. 6, 1989 for a “Hand-operated fruit picker” discloses a hand-operated fruit picker having a cage defining a fruit gathering chamber with a fruit receiving frontal opening, an upper concavity and a top central forwardly directed stem slit, and a gate hinged to the cage for movement from a fruit receiving to a fruit clamping position, is provided with an outwardly diverging scoop-like extension formed at the top forward margin of the opening to envelop the lateral members of a fruit cluster, and is further provided with removable chamber and gate linings of resilient tufted material contoured to extend the concavity of the chamber and serving to protect more sensitive and fragile fruits against bruising.

U.S. Pat. No. 1,795,392 to Hardwick issued March 1931 for an “Apple Picker” discloses an apple picker comprising a pole, a lever controlled picking device secured to an end of the pole, a hoop below said picking device, securing means for said hoop adapted to prevent pivotal movement thereof, a tubular contractible fabric member secured to said hoop and adapted to engage an apple throughout its descent, spaced snap buttons for securing said tubular member to the pole, and a receiving member below said tubular member.

U.S. Pat. No. 1,881,134 to Schling issued Oct. 4, 1932 for a “Fruit Picker” discloses in a fruit picker, a ring having a receptacle secured thereto and extending therefrom, said receptacle comprising a bag structure having an enlarged opening at the end secured to said ring and gradually narrowing down to a relatively narrow-like funnel, the bag opening being shaped to break the fall of fruit picked and feeding it to a funnel-like opening of cross-sectional area just sufficient to permit a slow gravitational movement of the fruit; a handle comprising a plurality of sections telescoping each other for varying the length of the handle; a bracket for securing said handle to said ring at the enlarged open end of the bag; a plurality of flexible metallic prongs; braces for securing said prongs to said handle at its upper end; and a plurality of spacers comprising cross bars, each provided with spaced perforations through which said prongs extend for maintaining said prongs in spaced relation with each other, said bars being movable longitudinally along said prongs for varying the spacing: thereof.

U.S. Pat. No. 2,935,836 to Angel issued May 1960 for a “Apple Picker” discloses an apple picker comprising, in combination, an elongated cylindrical pole having one transverse bore adjacent the upper end thereof and extending therethrough substantially perpendicular to the longitudinal axis thereof, one substantially circular shaped endless wire frame extending through said bore with the rear portion thereof integrally secured to said pole within said bore, the forward portion of said frame formed with a U-shaped extension having parallel sides and a semi-circular closed end portion, a substantially cylindrical elongated flexible sack closed at its bottom end, the top end of said sack formed with a seamed loop, said loop slidably receiving and enclosing said endless wire frame outside said post whereby it is attached thereto, and said seamed loop portion enclosing said U-shaped extension forming an elongated depending channel with parallel sides and a closed end portion for operatively engaging an apple on a tree to dislodge said apple therefrom by a downward pull upon said pole thereby allowing the apple to drop into said sack.

### SUMMARY AND ADVANTAGES

A fruit extractor for picking high hanging and difficult to reach fruit and other natural hanging food is provided. A fruit extractor includes including a container having an open top, blade slidably connected to said open top, such that said blade covers said open top in a closed position and uncovers said open top in a retracted position, a pole connected to said container, a retraction arm connected to said blade and pivotally connected to said pole, and a retraction line connected to said retraction arm for moving said arm to a retracted position. A fruit extractor including an elastic band, wherein said elastic band engages said pole and said retraction arm to create closing force on said blade through said arm. A fruit extractor including a brake line connected at a first end to said pole and at a second end to said retraction arm, wherein said brake line limits the maximum retraction position of said retraction arm. A fruit extractor including a pulley connected to said pole, wherein said retraction line is routed from said retraction arm through said pulley.

In another aspect of Applicant's novel fruit extractor, a fruit extractor includes an elongated handle having first and second ends, a container connected proximal to said handle first end, said container having an open top; a cutting arm having a first end, a second end, and a pivot connection point distal from said first end, said cutting arm pivotingly connected to said handle at said pivot connection point, a retraction line connected to said cutting arm at a retraction line connection point distal from said pivot connection point, a closing spring connected at a first spring end to said cutting arm at a location distal from said pivot connection point and connected at a second spring end to said handle, such that said closing spring opposes said cutting arm from pivoting said cutting arm first end away from said handle, and a cutting blade connected to said cutting arm proximal to said cutting arm first end and projecting in a non-parallel direction from said cutting arm, such that when said cutting arm first end is pivoted toward said handle said cutting blade covers said container open top, and when said cutting arm first end is pivoted away from said handle said blade uncovers said container open top. A fruit extractor where a pivot connection point is located proximal to said cutting arm second end. A fruit extractor a pivot connection point is located distal from both of said first and second cutting arm ends, and wherein said first spring end is connected to said cutting arm at a point opposite from said cutting blade in relation to said pivot connection point. A fruit extractor where a closing spring comprises an elastic strap.

The fruit extractor of the present invention presents numerous advantages, including that it allows a fruit picker to easily reach up to a high hanging fruit and pick it without climbing into the tree, climbing up on a ladder or otherwise becoming elevated, and which eliminates the risk that the fruit will drop to the ground, becoming damaged, bruised, or dirtied.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows an embodiment of Applicant's fruit extractor in use.

FIG. 2 shows an embodiment of Applicant's fruit extractor in the closed position.

FIG. 3 shows the embodiment of FIG. 2 in the open position.

FIG. 4 shows another embodiment of Applicant's fruit extractor.

### REFERENCE NUMBERS USED IN DRAWINGS

Turning now descriptively to the drawings, in which similar reference characters denote similar elements throughout the several views, the figures illustrate the fruit extractor of the present invention. With regard to the reference numerals used, the following numbering is used throughout the various drawing figures:
10 Fruit extractor
12 Container
14 Open top of container
16 Blade
18 Pole
20 Retraction arm
22 Retraction line
24 Pressure bands
26 Brake line
28 Pulley
30 Hinge
40 Second embodiment of a Fruit extractor
42 Spring
44 Pivot point
46 Pivoting retraction arm
F Fruit

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

A fruit extractor for picking high hanging and difficult to reach fruit and other natural hanging food is provided and includes in one aspect a container having an open top, blade slidably connected to said open top, such that said blade covers said open top in a closed position and uncovers said open top in a retracted position, a pole connected to said container, a retraction arm connected to said blade and pivotally connected to said pole, and a retraction line connected to said retraction arm for moving said arm to a retracted position. A fruit extractor including an elastic band, wherein said elastic band engages said pole and said retraction arm to create closing force on said blade through said arm. A fruit extractor including a brake line connected at a first end to said pole and at a second end to said retraction arm, wherein said brake line limits the maximum retraction position of said retraction arm. A fruit extractor including a pulley connected to said pole, wherein said retraction line is routed from said retraction arm through said pulley.

In another aspect, a fruit extractor includes an elongated handle having first and second ends, a container connected proximal to said handle first end, said container having an open top; a cutting arm having a first end, a second end, and a pivot connection point distal from said first end, said cutting arm pivotingly connected to said handle at said pivot connection point, a retraction line connected to said cutting arm at a retraction line connection point distal from said pivot connection point, a closing spring connected at a first spring end to said cutting arm at a location distal from said pivot connection point and connected at a second spring end to said handle, such that said closing spring opposes said cutting arm from pivoting said cutting arm first end away from said handle, and a cutting blade connected to said cutting arm proximal to said cutting arm first end and projecting in a non-parallel direction from said cutting arm, such that when said cutting arm first end is pivoted toward said handle said cutting blade covers said container open top, and when said cutting arm first end is pivoted away from said handle said blade uncovers said container open top. A fruit extractor where a pivot connection point is located proximal to said cutting arm second end. A fruit extractor a pivot connection point is located distal from both of said first and second cutting arm ends, and wherein said first spring end is connected to said cutting arm at a point opposite from said cutting blade in relation to said pivot connection point. A fruit extractor where a closing spring comprises an elastic strap.

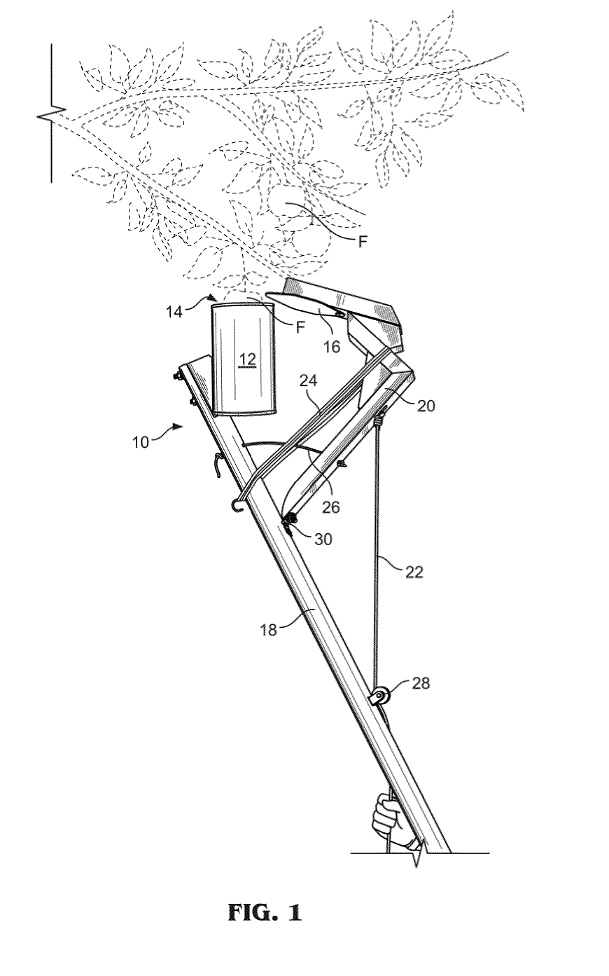

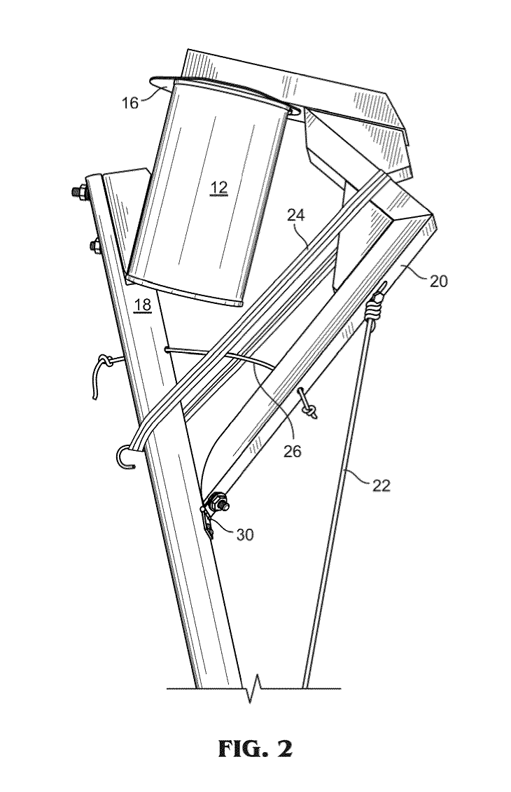

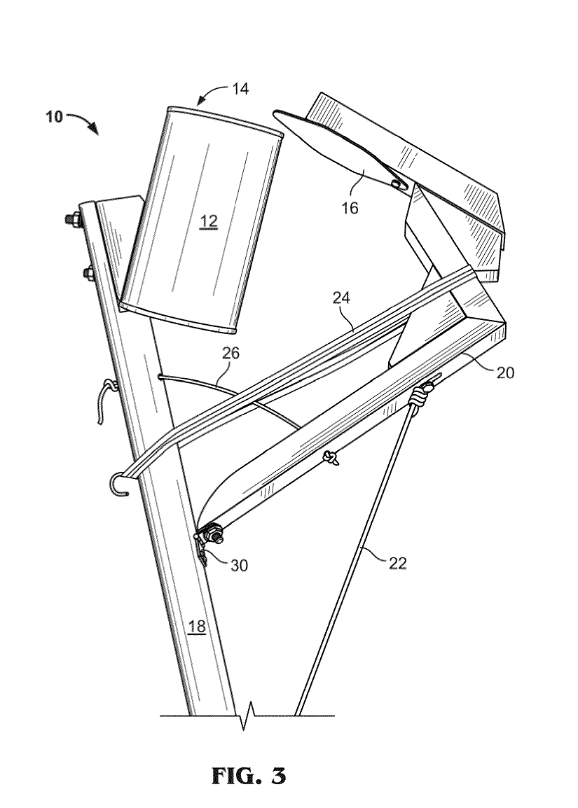

As shown in FIGS. 1-3, a fruit extractor 10 for picking high hanging and difficult to reach fruit and other natural hanging food is provided and includes a container 12 surrounding a fruit F to be picked with an open top 14, a blade 16 slidably covering said open top 14 in a closed position and opening said open top 14 in a retracted position, a pole 18 holding said container 12, a retraction arm 20 pivotally connected to said pole 18 and said blade 16 moving between a retracted and a closed position, and a retraction line 22 connected to said retraction arm 20 to move said arm 20 to a retracted position. Container 12 is preferably sized to catch and hold the fruit F being cut. In the preferred embodiment, pressure bands 24 engage said pole 18 and said retraction arm 20 to create closing pressure on said blade 16 through said arm 20. A brake line 26 engages said pole 18 and said retraction arm 20 to stop said retraction arm 20 from further retraction. A pulley 28 is provided on said pole 18 through which said retraction line 22 runs from said retraction arm 20 to a user. A hinge 30 connects the retraction arm 20 to the pole 18. Retraction arm 20 is preferably “L” shaped at such an angle that blade 16 in closed position is essentially horizontally parallel to open top 14. Pressure bands 24 are preferably rubber stretch bands but other pressure devices known to those of skill in the art, such as springs, could be used such as springs. Those of skill in the art will recognize that the blade 16 can be configured many ways without changing the function or nature of the invention, such as a round disk blade, a wedge shaped blade, or other known blade configurations.

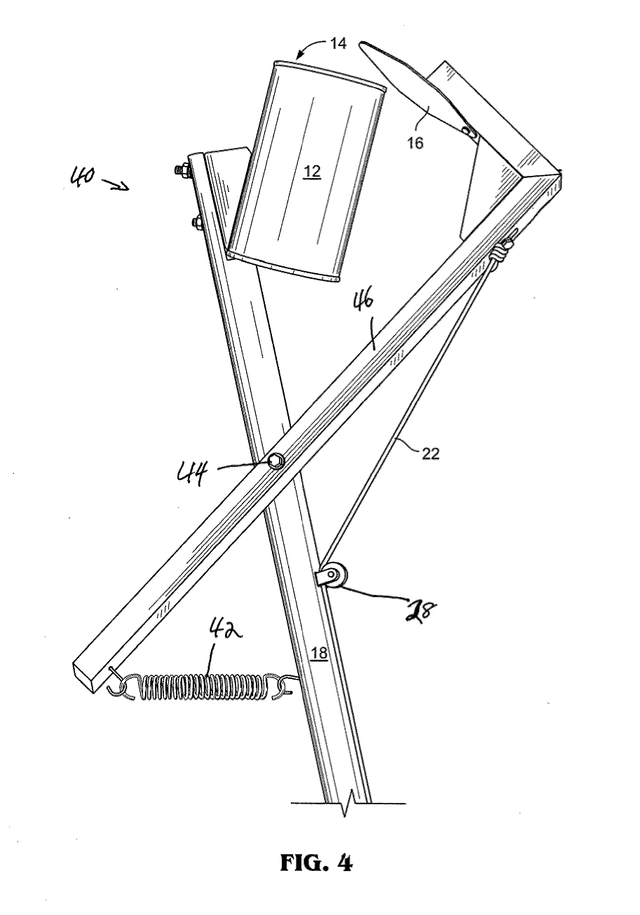

As shown in FIG. 4, in another embodiment of a fruit extractor 40 for picking high hanging and difficult to reach fruit F and other natural hanging food is provided and includes a container 12 surrounding a fruit F to be picked with an open top 14, a blade 16 slidably covering said open top 14 in a closed position and opening said open top 14 in a retracted position, a pole 18 holding said container 12, a pivoting retraction arm 46 pivotally connected to said pole 18 and said blade 16 moving between a retracted and a closed position, and a retraction line 22 connected to said pivoting retraction arm 46 to move said arm 46 to a retracted position. Container 12 is preferably sized to catch and hold the fruit F being cut. In this second embodiment a spring 42 connecting the pivoting retraction arm 46, preferably at the end distal from the blade 16 holding end, to the pole 18 create closing pressure on said blade 16 through said arm 46. A pulley 28 is provided on said pole 18 through which said retraction line 22 runs from said pivoting retraction arm 46 to a user. IN the second embodiment, pivoting retraction arm 46 connects to said pole 18 at a pivot point 44, preferably a bolt, about which said pole 18 pivots.

In operation in one embodiment, user raises container 12 on pole to a high hanging fruit F, pulls on retraction line 22 which causes retraction arm to pull blade 16 away from open top 14, when open top 14 is clear, inserts container 12 around fruit F, and then releases the retraction line 22 which engages the stem of the fruit F, clipping the fruit F from its connection to the tree. User then lowers pole 18 and pulls fruit out of the container 12 the user's leisure. It will be appreciated that one of the unique aspects of Applicant's invention is that the container 12 which surrounds, catches, and holds the fruit F being cut, provides counter pressure to the fruit F when the blade 16 on the retraction arm 20 is cutting the fruit F stem, assisting therefore in the cutting process. The container 12 then catches and holds the fruit F, protecting the fruit from falling to the ground and getting damaged, bruised, or dirtied.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A fruit extractor, comprising:
a container having an open top;
a blade slidably connected to said open top, such that said blade covers said open top in a closed position and uncovers said open top in a retracted position;
a pole connected to said container;
a retraction arm connected to said blade and pivotally connected to said pole; and
a retraction line connected to said retraction arm for moving said arm to a retracted position.

2. The fruit extractor of claim 1, further comprising an elastic band, wherein said elastic band engages said pole and said retraction arm to create closing force on said blade through said arm.

3. The fruit extractor of claim 1, further comprising a brake line connected at a first end to said pole and at a second end to said retraction arm, wherein said brake line limits the maximum retraction position of said retraction arm.

4. The fruit extractor of claim 2 further comprising a brake line connected at a first end to said pole and at a second end to said retraction arm, wherein said brake line limits the maximum retraction position of said retraction arm.

5. The fruit extractor of claim 1 further comprising a pulley connected to said pole, wherein said retraction line is routed from said retraction arm through said pulley.

6. The fruit extractor of claim 2 further comprising a pulley connected to said pole, wherein said retraction line is routed from said retraction arm through said pulley.

7. A fruit extractor comprising:
an elongated handle having first and second ends;
a container connected proximal to said handle first end, said container having an open top;
a cutting arm having a first end, a second end, and a pivot connection point distal from said first end, said cutting arm pivotingly connected to said handle at said pivot connection point;
a retraction line connected to said cutting arm at a retraction line connection point distal from said pivot connection point;
a closing spring connected at a first spring end to said cutting arm at a location distal from said pivot connection point and connected at a second spring end to said handle, such that said closing spring opposes said cutting arm from pivoting said cutting arm first end away from said handle; and
a cutting blade connected to said cutting arm proximal to said cutting arm first end and projecting in a non-parallel direction from said cutting arm, such that when said cutting arm first end is pivoted toward said handle said cutting blade covers said container open top, and when said cutting arm first end is pivoted away from said handle said blade uncovers said container open top.

8. The fruit extractor of claim 7, wherein said pivot connection point is located proximal to said cutting arm second end.

9. The fruit extractor of claim 7, wherein said pivot connection point is located distal from both of said first and second cutting arm ends, and wherein said first spring end is connected to said cutting arm at a point opposite from said cutting blade in relation to said pivot connection point.

10. The fruit extractor of claim 7, wherein said closing spring comprises an elastic strap.

11. The fruit extractor of claim 8, wherein said closing spring comprises an elastic strap.

12. The fruit extractor of claim 9, wherein said closing spring comprises an elastic strap.
